(19) United States
(12) Patent Application Publication
(10) Pub. No.: US 2025/0124510 A1
(43) Pub. Date: Apr. 17, 2025

(54) SYSTEMS, METHODS, AND MEDIA FOR TRACKING CAPITAL TRANSACTIONS

(71) Applicant: Philip M. Wood, Davie, FL (US)

(72) Inventor: Philip M. Wood, Davie, FL (US)

(21) Appl. No.: 18/981,842

(22) Filed: Dec. 16, 2024

Related U.S. Application Data
(60) Provisional application No. 63/544,442, filed on Oct. 16, 2023.

(51) Int. Cl. G06Q 40/06; G06Q 20/06; G06Q 20/38

(52) U.S. Cl. CPC G06Q 40/06; G06Q 20/06; G06Q 20/3827

(57) ABSTRACT

In some implementations, a system for tracking transactions can include memory; and one or more processors, wherein the one or more processors are configured at least to: receive a plurality of inputs, the plurality of inputs comprising: a first hash value generated based at least on a first portion of a first block of data of a first blockchain; a second hash value generated based at least on transaction information from one or more transactions, wherein the transaction information includes a first serial number or a vehicle identification number; wherein the one or more processors are further configured at least to: generate a second block of data based at least on the plurality of inputs; send at least the second block of data to a plurality of nodes for validation; and generate a second blockchain by combining the first blockchain with the second block of data.

### CROSS-REFERENCE TO RELATED APPLICATIONS

The present application claims priority to U.S. Provisional Application No. 63/544,442 filed Oct. 16, 2023, titled “SYSTEMS, METHODS, AND MEDIA FOR TRACKING CAPITAL TRANSACTIONS,” which is hereby incorporated by reference in its entirety.

### TECHNICAL FIELD

Embodiments generally relate to systems, methods, and media for tracking capital transactions.

### BACKGROUND

Buyers often have difficulty obtaining a clear understanding of the ownership history of capital, such as, for example, heavy equipment, motor vehicles, real estate properties, etc. There is a need for systems, methods, and media that can reliably record the entire transaction history of such capital, and that can make the record publicly available.

### SUMMARY

This summary is provided to introduce a variety of concepts and/or aspects in a simplified form that is further disclosed in the detailed description, below. This summary is not intended to identify key or essential inventive concepts of the claimed subject matter, nor is it intended for determining the scope of the claimed subject matter.

In one general aspect, a system of one or more computing devices can be configured to perform particular processes by virtue of having software, firmware, hardware, or a combination thereof installed on the system that in operation causes or cause the system to perform the processes. One or more computer applications can be configured to perform particular processes by virtue of including instructions that, when executed by one or more processors, cause the one or more processors to perform the processes.

In one general aspect, a system for tracking transactions can include memory; and one or more processors, wherein the one or more processors are configured at least to: receive a plurality of inputs, the plurality of inputs comprising: a first hash value generated based at least on a first portion of a first block of data of a first blockchain; a second hash value generated based at least on transaction information from one or more transactions, wherein the transaction information includes a first serial number or a vehicle identification number (VIN); wherein the one or more processors are further configured at least to: generate a second block of data based at least on the plurality of inputs; send at least the second block of data to a plurality of nodes for validation; and generate a second blockchain by combining the first blockchain with the second block of data. Other embodiments of this aspect include corresponding computer systems, apparatus, and computer programs recorded on one or more computer storage devices, each configured to perform the actions of the methods.

Implementations may include one or more of the following features. The system, wherein the one or more processors are further configured to: determine a first nonce value; determine a third hash value based at least on the plurality of inputs and the first nonce value; and compare the third hash value to a target value; wherein generating the second block of data comprises generating the second block of data based at least on the first nonce value and the plurality of inputs. Implementations of the described techniques may include hardware, a method or process, or a computer tangible medium.

In one general aspect, a method for tracking transactions can include receiving a plurality of inputs, the plurality of inputs comprising: a first hash value generated based at least on a first portion of a first block of data of a first blockchain; a second hash value generated based at least on transaction information from one or more transactions, wherein the transaction information includes a first serial number or a vehicle identification number; wherein the method further comprises generating a second block of data based at least on the plurality of inputs; sending at least the second block of data to a plurality of nodes for validation; and generating a second blockchain by combining the first blockchain with the second block of data. Other embodiments of this aspect include corresponding computer systems, apparatus, and computer programs recorded on one or more computer storage devices, each configured to perform the actions of the methods.

Implementations may include one or more of the following features. The method, further comprising determining a first nonce value; determining a third hash value based at least on the plurality of inputs and the first nonce value; and comparing the third hash value to a target value; wherein generating the second block of data comprises generating the second block of data based at least on the first nonce value and the plurality of inputs. Implementations of the described techniques may include hardware, a method or process, or a computer tangible medium.

A non-transitory computer-readable medium including one or more instructions that, when executed by one or more processors, cause the one or more processors to perform a method, the method comprising receiving a plurality of inputs, the plurality of inputs comprising: a first hash value generated based at least on a first portion of a first block of data of a first blockchain; a second hash value generated based at least on transaction information from one or more transactions, wherein the transaction information includes a first serial number or a vehicle identification number; wherein the method further comprises generating a second block of data based at least on the plurality of inputs; sending at least the second block of data to a plurality of nodes for validation; and generating a second blockchain by combining the first blockchain with the second block of data. Other embodiments of this aspect include corresponding computer systems, apparatus, and computer programs recorded on one or more computer storage devices, each configured to perform the actions of the methods.

Implementations may include one or more of the following features. The non-transitory computer-readable medium, wherein the method further comprises: determining a first nonce value; determining a third hash value based at least on the plurality of inputs and the first nonce value; and comparing the third hash value to a target value; wherein generating the second block of data comprises generating the second block of data based at least on the first nonce value and the plurality of inputs. Implementations of the described techniques may include hardware, a method or process, or a computer tangible medium.

### BRIEF DESCRIPTION OF THE DRAWINGS

A complete understanding of the present features or aspects and the advantages and features thereof will be more readily understood by reference to the following detailed description when considered in conjunction with the accompanying drawings wherein:

FIG. 1 illustrates a block diagram of a system for tracking capital transactions, according to some embodiments disclosed herein;

FIG. 2 illustrates a flow diagram of a method for tracking capital transactions, according to some embodiments disclosed herein;

FIG. 3 illustrates a flow diagram of a method for generating a blockchain, according to some embodiments disclosed herein; and

FIG. 4 illustrates a block diagram of a system for tracking capital transactions, according to some embodiments disclosed herein.

### DETAILED DESCRIPTION

Any specific details of features or aspects are used for demonstration purposes only, and no unnecessary limitations or inferences are to be understood therefrom. Before describing in detail exemplary aspects, it is noted that the aspects reside primarily in combinations of components and procedures related to the system and/or apparatus. Accordingly, the system and/or apparatus components have been represented where appropriate by conventional symbols in the drawings, showing only those specific details that are pertinent to understanding the aspects of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship, or order between such entities or elements. Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary aspects of the inventive concepts defined in the appended claims. Hence, specific steps, process order, dimensions, component connections, and other physical characteristics relating to the aspects disclosed herein are not to be considered as limiting, unless the claims expressly state otherwise. The use or mention of any single element contemplates a plurality of such element, and the use or mention of a plurality of any element contemplates a single element (for example, “a device” and “devices” and “a plurality of devices” and “one or more devices” and “at least one device” contemplate each other), Regardless of whether particular variations are identified and/or described, unless impractical, impossible, or explicitly limited.

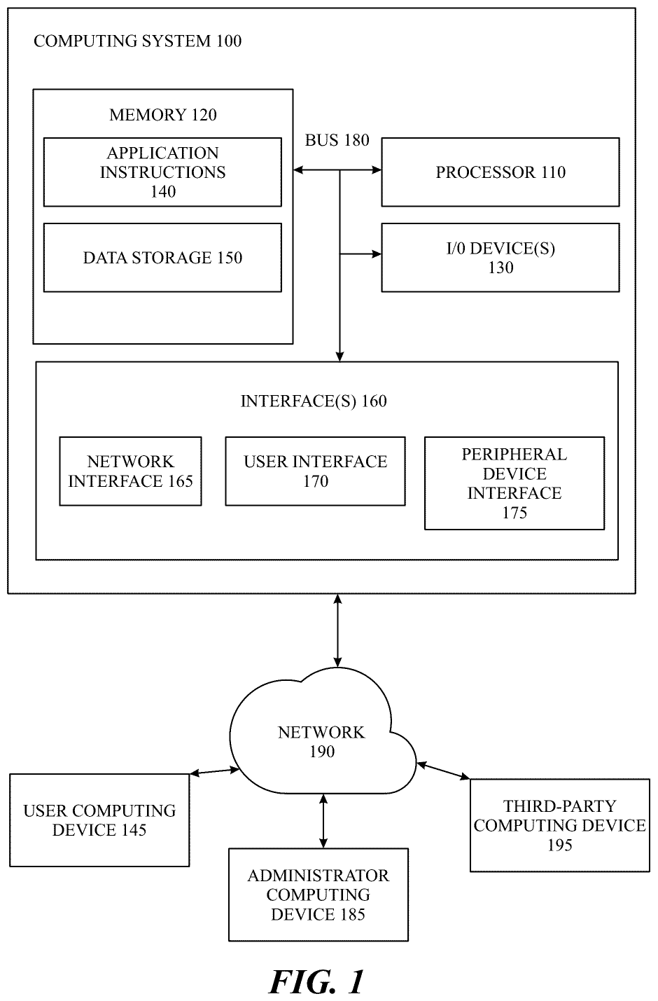

The disclosed system, method, and media are configured for tracking capital transactions in a secure, scalable, and efficient blockchain system. The disclosed system, method, and media may be configured for digitizing vehicle and real estate titles, enabling more efficient and secure title transfers to reduce risks, enhance transparency, and simplify the title tracking and management process. FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer-readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer-readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer-readable storage medium (or media) can be a tangible device that can retain and store instructions for use by an instruction execution device. The computer-readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer-readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer-readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present disclosure.

In some embodiments, the application instructions 140 can be downloaded to a computing/processing device from a computer-readable storage medium, or to an external computer or external storage device via a network 190. A network adapter card or network interface in each computing/processing device receives computer-readable program instructions from the network and forwards the computer-readable application instructions 140 for storage in a computer-readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

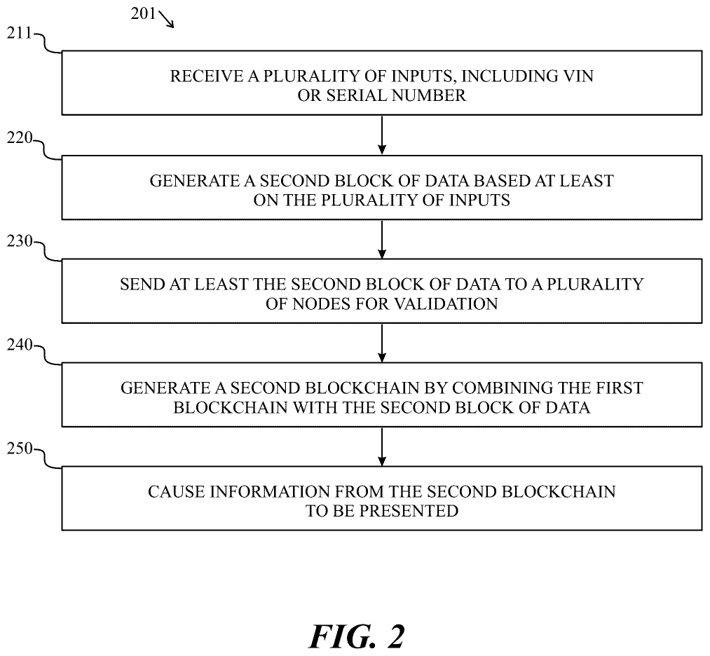

FIG. 2 illustrates a process 201 for tracking transactions. The system 100 can be configured to perform the process 201 or any combination of subprocesses thereof, according to some embodiments. The process 201 can include receiving 210 a plurality of inputs. The plurality of inputs 211 can include a product identification number. The identification number can be associated with, and can be used to identify, any product. The product identification number can include a first serial number. The first serial number may be associated with any product, document, object, or device, such as, but not limited to, a vehicle, phone, computer, watch, loan, lien, title, etc. The product can include any tangible asset, such as, for example, a commercial product. The product can be new or used. The product can include any product sold by any entity, such as, for example, a corporation, a company, a group of persons, a person, etc. The product can include any equipment, machinery, one or more tools, etc. The product can include, for example, an electronic device, a medical device, a household item, a furniture item, an appliance, a clothing item, a media item (e.g., a video, a movie, an album, a song, print media, a book, an image, etc., or a portion thereof), etc.

In some embodiments, the plurality of inputs can include a model number associated with any product, such as scanning of a VIN or serial number associated with a title. The model number can indicate a version of a product. In some embodiments, the product can be an intangible asset. For example, the product can be a vehicle registration with any government entity, such as, for example, a department of motor vehicles. In some embodiments, the product can include a motor vehicle. In such embodiments, the plurality of inputs can include a vehicle identification number. The vehicle identification number can be associated with, and can be used to identify, any vehicle, including any motor vehicle. The plurality of inputs can include a property identification number. The property identification number can be associated with, and can be used to identify, any property, such as, for example, real estate property, fractionalized real estate property, including any parcel of land and any building(s) thereon. Fractional real estate property can be facilitated through, for example, real estate investment trusts, crowdfunding platforms, or blockchain technology, where tokenized assets represent ownership. Ownership of tokenized assets may be represented by serial numbers. The property identification number can include a tax identification number associated with a property, a parcel number, an assessment roll number, a folio number, a land lot number, a property account number, a survey number, a location identifier, or any combination thereof. In some embodiments, the system is configured to provide title search functionality including, but not limited to, retrieving historical ownership details and legal descriptions of properties, identifying existing mortgages, liens, judgments, or easements, generate reports including summarizing findings in a title report for stakeholders, like buyers, sellers, or lenders, and streamlining repetitive tasks like document retrieval and data entry.

The plurality of inputs can include an entity identification number. The entity identification number can be associated with, and can be used to identify, any entity. The entity identification number can include vehicle insurance information, such as, insurance coverage levels, expiration information, etc. The entity identification number can include a tax identification number. The tax identification number can be a social security number, an employer identification number, etc. The entity identification number can include a driver's license number, a registration number, etc.

The plurality of inputs can include one or more maintenance records associated with any product or property. A maintenance record can indicate the maintenance performed for any product or property, the parts of the product or property involved in the maintenance, the date at which the maintenance was performed, and any other suitable information associated with the maintenance performed.

The plurality of inputs can include one or more accident reports. An accident report can indicate the type of accident a vehicle was involved in (e.g., collision), the parts of the vehicle damaged during the accident, the cost to repair the vehicle, the date the accident occurred, VINs of other vehicles involved in the accident, an indication of whether the vehicle has a salvaged title, or any other information associated with the accident.

The plurality of inputs can include lien information associated with any property, such as, for example, real estate property. The lien information can include any information associated with any lien. For example, the lien information can indicate the date a lien was filed, the entity that is the lien holder, the amount owed based on the lien, the lien type, or any other information associated with the lien.

The plurality of inputs can include any theft information associated with any product or property. The theft information can include any information associated with any theft, including the date the theft occurred, any damage caused by the theft, any items stolen, or any other information associated with any theft.

The plurality of inputs can include a first hash value generated based at least on a first portion of a first block of data of a first blockchain. The first portion of the first block of data of the first blockchain can include a header of the blockchain. The first hash value is a digital representation of the first block of data of the first blockchain. In some embodiments, the first portion of the first block of data can include another plurality of inputs used to generate the first block of data.

The plurality of inputs can include a second hash value generated based at least on transaction information from one or more transactions. In some embodiments, any of the plurality of inputs can be included in the transaction information. The second hash value is a digital representation of the one or more transactions. In some embodiments, the second hash value is a Merkle root of the transaction information from the one or more transactions. For example, transaction information from each transaction can be hashed using a cryptographic hash function (e.g., SHA-256). Pairs of hash values of transaction information of respective transactions can be combined (e.g., concatenated) and each combination can be hashed. This can be repeated until a single hash value is generated. The single hash value is the Merkle root.

The one or more transactions can include one or more transactions involving one or more products, one or more properties, and/or one or more entities (including, e.g., one or more buyers and one or more sellers). A transaction can include a transfer of ownership of one or more products and/or one or more properties from one or more entities to another one or more entities in exchange for valuable consideration (e.g., money). A transaction can include a license or registration granted by one or more entities for another one or more entities in exchange for valuable consideration (e.g., money).

The transaction information can include any suitable information about the one or more transactions. For example, the transaction information can include information about the one or more products, one or more properties, one or more entities involved in the one or more transactions, one or more licenses, one or more registrations, etc., or any combination thereof. The transaction information can include a time a transaction occurred, the location the transaction occurred, the amount of money paid to a seller by a buyer, the buyer's address (e.g., digital wallet address), the seller's address (e.g., digital wallet address), the buyer's public key, the seller's public key, the transaction fee paid to one or more validators of the transaction, one or more digital signatures generated by the seller, one or more digital signatures generated by the buyer, the transaction status (e.g., failed, pending, complete), facial recognition data, eye exam data, license information such as, height, weight, biometric data such as thumbprint data, etc., or any combination thereof.

In some embodiments, the plurality of inputs can include a time at which the first block of data was generated. The process 201 can include generating 220 a second block of data based at least on the plurality of inputs. The second block of data can be generated using any suitable method. In some embodiments, the plurality of inputs is combined with the transaction information to generate the second block of data. In some embodiments, the plurality of inputs can be formatted in any suitable first format. The transaction information can be formatted in any suitable second format. In some embodiments, the second block of data can be formatted in any suitable third format.

In some embodiments, the process 201 can include validating each of the transactions whose information is included in the transaction information. Each of the transactions can be validated by using any suitable method. For example, any digital signature can be validated using one or more digital wallet addresses and/or public keys to validate a transaction.

In some embodiments, the process 201 can include sending 230 at least the second block of data to a plurality of nodes (e.g., computing devices in a network) for validation. In some embodiments, each node can validate each of the transactions whose information is included in the transaction information.

The process 201 can include generating 240 a second blockchain by combining the first blockchain with the second block of data. The first blockchain can be combined with the second block of data by using any suitable method. In some embodiments, the second block of data is appended to the first blockchain to generate the second blockchain. In some embodiments, the first blockchain and the second block of data can be concatenated to generate the second blockchain.

In some embodiments, the process 201 can further include including the second blockchain with any suitable title of ownership. A title of ownership can be any legal document indicating evidence of ownership and rights to a specific piece of product or property.

The process 201 can include receiving a request to view the second blockchain. In response, the process 201 can include causing 250 information from the second blockchain to be presented. The information can indicate an entire transaction history of one or more products, one or more properties, one or more licenses, and/or one or more registrations associated with the second blockchain. The information can indicate a current ownership of the one or more products, one or more properties, one or more licenses, and/or one or more registrations.

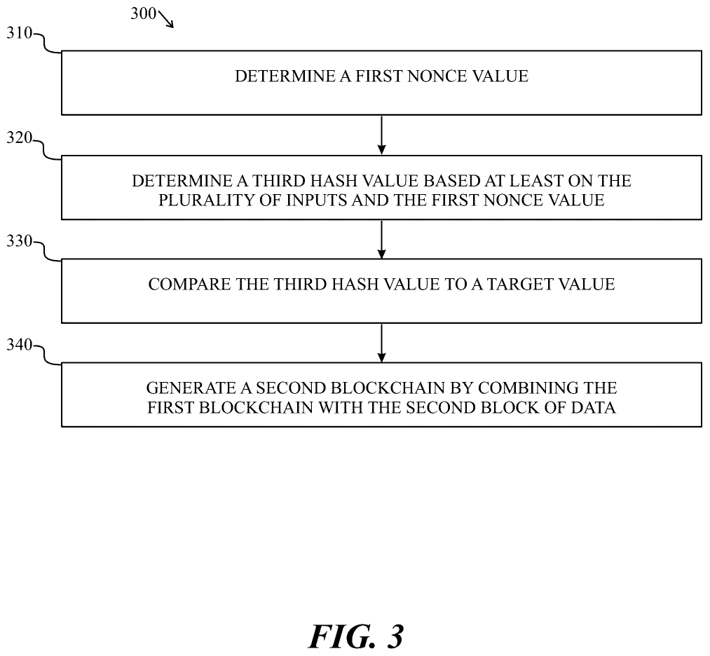

FIG. 3 illustrates a process 300 for generating a second blockchain, according to some embodiments. The process 300 can include determining 310 a first nonce value. The first nonce value can be determined using any suitable method. For example, the first nonce value can be randomly generated. A randomly generated number can include a pseudorandom number. In some embodiments the first nonce value can be within a predetermined range of values.

The process 300 can include determining 320 a third hash value based at least on the plurality of inputs and the first nonce value. The third hash value can be determined using any suitable method. In some embodiments, the third hash value can be generated using one or more hashing functions, including, for example an SHA-256 function applied to the plurality of inputs and the first nonce value.

The process 300 can include comparing 330 the third hash value to a target value. The comparison can be performed using any suitable method. In some embodiments, the third hash value can be compared to the target value by determining if the third hash value is less than, equal to, or less than or equal to, the target value. In some embodiments, the third hash value can be compared to the target value by determining if the third hash value is greater than, equal to, or greater than or equal to, the target value.

The process 300 can include generating 340 a second block of data based at least on the first nonce value and the plurality of inputs. In some embodiments, the second block of data can be generated by combining the first nonce value and the plurality of inputs. The first nonce value and any of the plurality of inputs can be included in a first portion of the second block of data. In some embodiments, the first portion of the second block of data is a header of the second block of data. In some embodiments, the first portion can be combined with the transaction information to generate the second block of data.

In some embodiments, the process 300 can include sending any information associated with the second block of data to one or more nodes for validation. Each of the nodes can validate the second block of data by comparing the first nonce value to the target value. In response, each of the nodes can generate the second block of data. The process can be included in any other suitable process, such as, for example, a process for processing a transaction.

The process for processing a transaction can include receiving a request to purchase one or more products, one or more properties, one or more licenses, and/or one or more registrations from one or more entities (e.g., buyers). The process can further include sending, to one or more servers, the request, including at least any payment information and information identifying the one or more products, one or more properties, one or more licenses, and/or one or more registrations. The process can include receiving a response to the request. The response can indicate that the request is approved. If approved, the process can further include generating transaction information. After generating the transaction information, the process can further include a process, such as, for example process 201 and/or process 300.

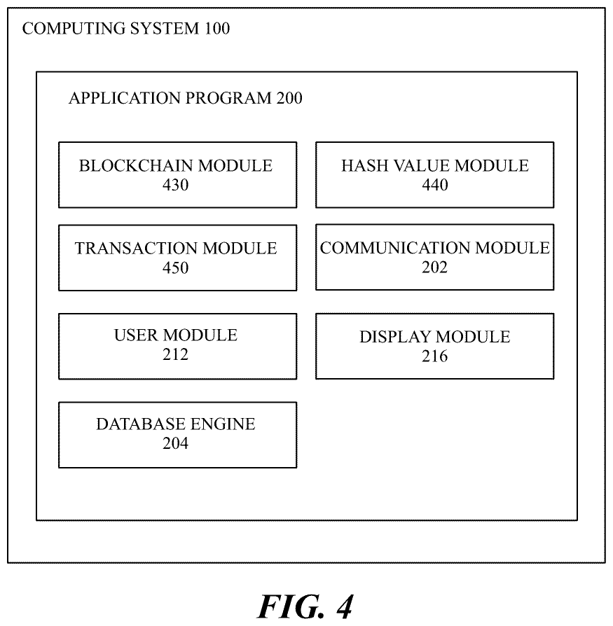

FIG. 4 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 4 is a block diagram showing the modules and engines needed to perform specific tasks within the application program 200.

Referring to FIG. 4, the computing system 100 operating the application program 200 comprises one or more modules having the necessary routines and data structures for performing specific tasks, and one or more engines configured to determine how the platform manages and manipulates data. In some embodiments, the application program 200 comprises one or more modules, including a blockchain module 430, a hash value module 440, a user module 212, a communication module 202, a database engine 204, and a display module 216.

In some embodiments, transaction module 450 is configured to track transactions as described with respect to FIG. 2. The one or more transactions can include one or more transactions involving one or more products, one or more properties, and/or one or more entities. A transaction can include a transfer of ownership of one or more products and/or one or more properties from one or more entities to another one or more entities in exchange for valuable consideration. A transaction can include a license or registration granted by one or more entities for another one or more entities in exchange for valuable consideration. For example, transactions may be associated with vehicles and corresponding information, accident reports, properties, etc. The transaction module 450 tracks transactions, for example, via a distributed ledger to ensure transparency, security, and consistency. In embodiments, the transaction module 450 tracks transactions by monitoring the communication of transactions to computing nodes on a network, where nodes may validate transactions via consensus mechanisms.

In some embodiments, the blockchain module 430 is configured to generate a first or second block of data based at least on the plurality of inputs and send the first or second block of data to a plurality of nodes for validation. The blockchain module 430 is configured to generate a blockchain by combining a first blockchain with a second block of data. For example, the blockchain module 430 may add transactions identified and validated by the transaction module 450 to a sequential chain of blocks, where blocks contain transactions, unique hashes linking blocks sequentially, a timestamp, etc.

In some embodiments, the hash value module 440 is configured to generate hash values based on tracked transactions, as described with respect to FIG. 2. The hash module 440 is configured to generate a first hash value based at least on the first portion of the first block of data of a first blockchain. The hash value module 440 is configured to generate hash values based at least on transaction information from one or more transactions tracked via the transaction module 450. In embodiments, the transaction module 450 generates hash values via hash functions (algorithms), that convert input data into a fixed-size output.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 302 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

It will be understood that it would be unduly repetitious and obfuscating to describe and illustrate every reordering, combination and subcombination of the elements and the aspects described. Accordingly, all elements can be combined in any way and/or combination, and the present specification, including the drawings, shall be construed to constitute a complete written description of all reorderings, combinations and subcombinations of the elements and of the aspects described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of’).

I/We claim:

1. A system for tracking capital transactions comprising:
at least one computing device in operable communication with a network;
an application server in operable communication with the at least one computing device over the network, the application server configured to host an application program configured to:
receive a plurality of inputs comprising:
a first hash value generated based at least on a first portion of a first block of data of a first blockchain;
a second hash value generated based at least on transaction information from one or more transactions, wherein the transaction information includes a first serial number or a vehicle identification number;
generate a second block of data based at least on the plurality of inputs;
send at least the second block of data to a plurality of nodes for validation; and
generate a second blockchain by combining the first blockchain with the second block of data.

2. The system for tracking capital transactions of claim 1, wherein the application program is further configured to:
determine a first nonce value;
determine a third hash value based at least on the plurality of inputs and the first nonce value; and
compare the third hash value to a target value, wherein generating the second block of data comprises generating the second block of data based at least on the first nonce value and the plurality of inputs.

3. The system for tracking capital transactions of claim 2, wherein the first nonce value is randomly generated.

4. The system for tracking capital transactions of claim 2, wherein the first nonce value is a pseudorandom number.

5. The system for tracking capital transactions of claim 2, further comprising validating the second block of data by comparing the first nonce value to the target value.

6. The system for tracking capital transactions of claim 1, wherein the first hash value and the second hash value are generated via hash functions that convert the plurality of inputs into one or more fixed-size outputs.

7. The system for tracking capital transactions of claim 1, wherein the second hash value is a Merkle root of transaction information from the plurality of inputs.

8. A method for tracking transactions, comprising:
receiving, via a computing device, a plurality of inputs, the plurality of inputs comprising:
a first hash value generated based at least on a first portion of a first block of data of a first blockchain;
a second hash value generated based at least on transaction information from one or more transactions, wherein the transaction information includes a first serial number or a vehicle identification number;
generating, via the computing device, a second block of data based at least on the plurality of inputs;
sending, via the computing device, at least the second block of data to a plurality of nodes for validation; and generating a second blockchain by combining the first blockchain with the second block of data.

9. The method of claim 8, further comprising:
determining a first nonce value;
determining a third hash value based at least on the plurality of inputs and the first nonce value; and
comparing the third hash value to a target value, wherein generating the second block of data comprises generating the second block of data based at least on the first nonce value and the plurality of inputs.

10. The method of claim 9, wherein the first nonce value is randomly generated.

11. The method of claim 9, wherein the first nonce value is a pseudorandom number.

12. The method of claim 9, further comprising validating the second block of data by comparing the first nonce value to the target value.

13. The method of claim 8, wherein the first hash value and the second hash value are generated via hash functions that convert the plurality of inputs into one or more fixed-size outputs.

14. The method of claim 8, wherein the second hash value is a Merkle root of transaction information from the plurality of inputs.

15. A software product comprising at least one computer-readable storage media having application instructions collectively stored on the at least one computer-readable storage media, the application instructions executable to:
receive a plurality of inputs, the plurality of inputs comprising:
a first hash value generated based at least on a first portion of a first block of data of a first blockchain;
a second hash value generated based at least on transaction information from one or more transactions, wherein the transaction information includes a first serial number or a vehicle identification number;
generate a second block of data based at least on the plurality of inputs;
send at least the second block of data to a plurality of nodes for validation; and
generate a second blockchain by combining the first blockchain with the second block of data.

16. The software product of claim 15, wherein the application instructions are further executable to:
determine a first nonce value;
determine a third hash value based at least on the plurality of inputs and the first nonce value; and
compare the third hash value to a target value, wherein generating the second block of data comprises generating the second block of data based at least on the first nonce value and the plurality of inputs.

17. The software product of claim 17, wherein the nonce value is randomly generated.

18. The software product of claim 17, wherein the application instructions are further executable to validate the second block of data by comparing the first nonce value to the target value.

19. The software product of claim 17, wherein the first hash value and the second hash value are generated via hash functions that convert the plurality of inputs into one or more fixed-size outputs.

20. The software product of claim 15, wherein the second hash value is a Merkle root of transaction information from the plurality of inputs.
